(19) United States
(12) Patent Application Publication
(10) Pub. No.: US 2011/0181832 A1
(43) Pub. Date: Jul. 28, 2011

(54) EYEWEAR SYSTEM FOR THE TREATMENT OF UNILATERAL NEGLECT SYNDROME

(76) Inventors: Brian Patrick Smith, Union City, GA (US); Ashanti R. Young, Birmingham, AL (US)

(21) Appl. No.: 13/080,648

(22) Filed: Apr. 5, 2011

Related U.S. Application Data
(63) Continuation-in-part of application No. 12/355,755, filed on Jan. 16, 2009, now Pat. No. 7,942,524.

(51) Int. Cl. G02C 11/04

(52) U.S. Cl. 351/158

(57) ABSTRACT

An eyewear system for the treatment of unilateral neglect syndrome is disclosed. The eyewear system includes an eyewear device, a lens system, flashcards, an LED/light emitting source system integrated into the eyewear device, a remote control for selective activation of the LED/light emitting source system, and instructional media on the use of the eyewear system. In at least one embodiment, the LED/light emitting source system is visible simultaneously to both the patient and the health care practitioner or system monitor.

### CROSS-REFERENCE TO RELATED APPLICATION(S)

This present non-provisional patent application is a continuation-in-part of copending U.S. patent application Ser. No. 12/355,755 filed on Jan. 16, 2009, and entitled “EYEWEAR SYSTEM FOR THE TREATMENT OF UNILATERAL NEGLECT SYNDROME,” and of which the application cited above is incorporated in-full by reference herein.

### FIELD OF THE INVENTION

The technology described herein relates generally to the field of treatment systems. More specifically, this technology relates to a system for the treatment of unilateral neglect syndrome (UNS).

### BACKGROUND OF THE INVENTION

The technology described herein relates to devices, and methods thereof, that aid in the rehabilitation of individuals who exhibit signs and/or symptoms of unilateral neglect as a resultant of brain dysfunction, e.g., from cerebral vascular accident, traumatic brain injury, and/or brain tumor.

Individuals with this syndrome act as though whole regions of space contralateral to their lesions do not exist. In early stages, patients may deny ownership of their contra-lateral limb and also neglect parts of their own body. When dressing, they might not clothe the contralateral side and may fail to groom their hair or shave parts of their faces on that side.

Right hemisphere damage is a more common and more severe cause of unilateral neglect than left hemisphere damage. Damage causing left-sided neglect is usually centered on the inferior parietal lobule or superior temporal lobe of the right hemisphere. Patients with such damage ignore events occurring on the left side of space. Patients may even fail to eat the food on the left side of their plate or bump into obstacles on their left side.

Individuals suffering from unilateral neglect often exhibit poor self care skills and often require 24 hour care due to poor safety awareness, secondary to inability to process/scan their entire environment. To regain as much functional independence as possible, the brain much first recognize that the neglected side of the body still exists.

Extensive assistance from external caregivers is needed in order to rehabilitate individuals with brain injuries that result in unilateral neglect symptoms and who are currently unable to perform basic activities of daily living (ADL) skills. There is a need in this field for an improved rehabilitation system that is cost effective, easy to use, and effective.

Related patents known in the art include the following: U.S. Pat. No. 3,505,679, issued to Bennett on Apr. 14, 1970, discloses a removable eye side shield. U.S. Pat. No. 5,503,637, issued to Kyricos et al. on Apr. 2, 1996, discloses an apparatus for producing and delivering high-intensity light to the eyes of a subject to modify the subject's circadian phase. U.S. Pat. No. 6,350,275, issued to Vreman et al. on Feb. 26, 2002, discloses a device for treating a circadian rhythm disorder in a subject. U.S. Pat. No. 6,942,336, issued Foulke et al. on Sep. 13, 2005, discloses opaque films adhering electrostatically to lenses of eyewear to train baseball fielders and golfers. U.S. Pat. No. 7,364,583, issued to Eels et al. on Apr. 8, 2008, discloses a system for exposure of eyes of a user to light.

Related published patent applications known in the art include the following: U.S. Published Patent Application 2003/0109906, inventor Streeter, published on Jun. 12, 2003, discloses therapeutic methods for the treatment of stroke; the methods including delivering a neuroprotective effective amount of light energy having a wavelength in the visible to near-infrared wavelength range to that area of the brain containing the area of primary infarct. U.S. Published Patent Application 2006/0224217, inventor Burgmann et al., published on Oct. 5, 2006, discloses a phototherapy device which includes a light source for emitting light of a suitable wavelength and a programmable controller connectable to the light source for controlling the power supplied to the light source. U.S. Published Patent Application 2006/0136018, inventor Lack et al, published Jun. 22, 2006, discloses an apparatus for administering light to effect re-timing of the human body clock.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides a system for the treatment of unilateral neglect syndrome. This system is comprised of devices and associated methods directed to the treatment of UNS.

The technology described herein utilizes one or more devices that are specifically designed to retrain the injured cerebrum of the brain to process visual stimuli to the affected side of the body so that an affected individual can regain functional scanning and tracking abilities so that he/she can actively participate in basic ADL tasks

To assist an individual with unilateral neglect/inattention deficits, an eyewear system is used that gradually progresses an individual with UNS to independently scan and track objects on the affected side of the body by using lights, e.g., LED lights, and flash cards as measurable, quantifiable data to track and document progress.

The technology described herein pertains to a non-invasive retraining tool that reeducates a user to the use of the neglected side of the body. This neglect is observed in stroke or accident victims who have fairly extensive damage to the posterior (parietal or parieto-occipital) regions of the right hemisphere of the brain. It sometimes occurs after similar damage to the left hemisphere, but much less frequently and in milder form. The impression a caregiver gets in observing such a patient is that he/she behaves as if the whole left or right side of space, and sometimes even the left or right side of his/her own body, does not exist.

An advantage of the technology described herein is that benefiting from the use of these system are individuals who exhibit neglect or inattention to either the left or right side of the body and cannot complete basic activities of daily living skills due to CVA or brain injury. (Examples given include; reading, writing, upper body dressing, lower body dressing, toileting, self feeding, wheelchair propulsion, facial makeup application, shaving, brushing teeth, combing hair, cleaning dentures, donning and doffing of hearing aids, washing of hair, performing functional transfers, and tracking/scanning towards visual or auditory stimuli.)

In one exemplary embodiment, the technology described herein provides eyewear frames for the treatment of unilateral neglect syndrome experienced by a subject. The eyewear frames include: a left rim having a left lens area for receiving a first and a second left lens, the first and second left lenses configured for placement in the left lens area individually or in combination, adjacent one to another; a right rim having a right lens area for receiving a first and a second right lens, the first and second right lenses configured for placement in the right lens area individually or in combination, adjacent one to another; a plurality of light-emitting diodes (LEDs)/light emitting sources disposed upon the eyewear frames and configured to emit a plurality of varied light patterns toward a subject wearing the eyewear frames to provide stimulation, the plurality of LEDs/light emitting sources also configured for visibility to a non-wearer from all possible fields of vision for a non-wearer of the eyewear frames. The eyewear frames are configured for disposition upon the subject, and a left eye and a right eye are partially or fully occluded in a plurality of varied patterns, to aid in the treatment of unilateral neglect syndrome and stimulate response in a neglected side of the body of the subject.

The eyewear frames also can include: a left end piece coupled to the left rim and having a left temple area; a right end piece coupled to the right rim and having a right temple area; a removable left temple block, configured for placement within the left temple area; and a removable right temple block, configured for placement within the right temple area.

In at least one embodiment, the plurality of LEDs/light emitting sources disposed upon the eyewear frames are further configured to extend from the left rim and the right rim for placement in a line of vision of the subject through the left lens area and the right lens area.

In at least one embodiment, the plurality of LEDs/light emitting sources disposed upon the eyewear frames are further configured to operate in sequence, thereby able to illuminate numerous LEDs/light emitting sources simultaneously, one or more LEDs/light emitting sources proximate to the left eye, and one or more LEDs/light emitting sources proximate to the right eye, thereby operative in tandem to draw the left and right eyes to scan and track toward a target direction.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a perspective view of an eyewear device, illustrating, in particular, an individual wearing the eyewear device, according to an embodiment of the technology described herein;

FIG. 2 is a rear view of the eyewear device, according to an embodiment of the technology described herein;

FIG. 3 is a rear view of the eyewear device of FIG. 2, illustrating, in particular, a numbering arrangement for LEDs/light emitting sources, according to an embodiment of the technology described herein;

FIG. 4 is a top plan view of a remote control device, illustrating, in particular, button arrangements corresponding to LEDs/light emitting sources for the eyewear device of FIG. 3, according to an embodiment of the technology described herein;

FIG. 5 illustrates the use of a flashcard with an individual wearing an eyewear device having partially occluded lenses installed, according to an embodiment of the technology described herein;

FIG. 6 illustrates an individual wearing an eyewear device, illustrating, in particular, partially occluded lenses installed, according to an embodiment of the technology described herein;

FIG. 7 is a front plan view of an eyewear device, according to an embodiment of the technology described herein;

FIG. 8 is a rear plan view of an eyewear device, according to an embodiment of the technology described herein;

FIG. 9 is a side plan view of an eyewear device, according to an embodiment of the technology described herein;

FIG. 10 is a top plan view of an eyewear device, according to an embodiment of the technology described herein;

FIG. 11 is a bottom plan view of an eyewear device, according to an embodiment of the technology described herein;

FIG. 12 is a perspective view of an eyewear device, according to an embodiment of the technology described herein;

FIG. 13 is a front plan view of an eyewear device, illustrating, in particular, slots for inserting lenses, according to an embodiment of the technology described herein;

FIG. 14 is a rear plan view of the eyewear device of FIG. 13, according to an embodiment of the technology described herein;

FIG. 15 is a side plan view of the eyewear device of FIG. 13, illustrating, in particular, slots for inserting lenses, according to an embodiment of the technology described herein;

FIG. 16 is a top plan view of the eyewear device of FIG. 13, illustrating, in particular, slots for inserting lenses, according to an embodiment of the technology described herein;

FIG. 17 is a bottom plan view of the eyewear device of FIG. 13, according to an embodiment of the technology described herein;

FIG. 18 is a perspective view of an eyewear device, illustrating, in particular, a slot arrangement for lens insertion, according to an embodiment of the technology described herein;

FIG. 19 is a front plan view of an eyewear device, illustrating, in particular, a slot arrangement for lens insertion, according to an embodiment of the technology described herein;

FIG. 20 is a front plan view of an eyewear device, illustrating, in particular, a slot arrangement for lens insertion, according to an embodiment of the technology described herein;

FIG. 21 is a front plan view of a button arrangement for a remote control device, illustrating, in particular, a film overlay on the desired button for home treatment, according to an embodiment of the technology described herein;

FIG. 22A is a front plan view of a pair of side lenses, illustrating, in particular, thin film occluded lenses for overlaying clear side lenses of an eyewear device, according to an embodiment of the technology described herein;

FIG. 22B is a front plan view of a pair of side lenses, illustrating, in particular, plastic occluded lenses for insertion into an eyewear device, according to an embodiment of the technology described herein;

FIG. 23A is a front plan view of a pair of front lenses, illustrating, in particular, thin film occluded lenses for overlaying clear front lenses of an eyewear device, according to an embodiment of the technology described herein;

FIG. 23B is a front plan view of a pair of front lenses, illustrating, in particular, plastic occluded lenses for insertion into an eyewear device, according to an embodiment of the technology described herein;

FIG. 24 is a front plan view of representative flash cards for use with an eyewear system, according to an embodiment of the technology described herein;

FIG. 25 is a side elevation view of an eyewear device, illustrating, in particular, the eyewear system device prior to insertion of side lenses, according to an embodiment of the technology described herein; and

FIG. 26 is a side elevation view of an eyewear device, illustrating, in particular, the eyewear system device after insertion of side lenses, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an eyewear system. The eyewear system provides a caregiver with tools for the treatment of UNS. In the illustrative embodiment, the eyewear system is utilized in a medical professional environment. It will be apparent however to those in the art that the eyewear system can be utilized in varied other environments.

The technology described herein provides an eyewear system to rehabilitate individuals with various brain injuries who have acquired unilateral neglect symptoms, who are currently unable to perform basic activities of daily living skills and who require extensive assistance from external caregivers.

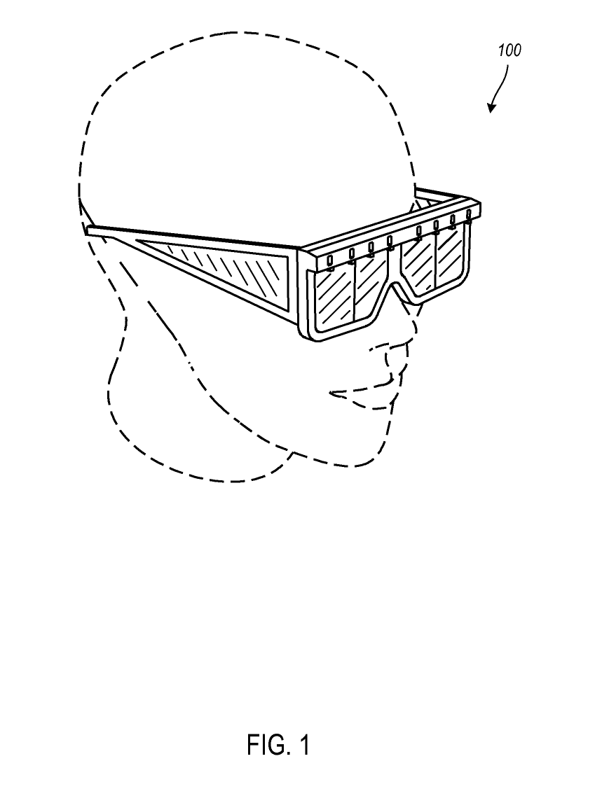

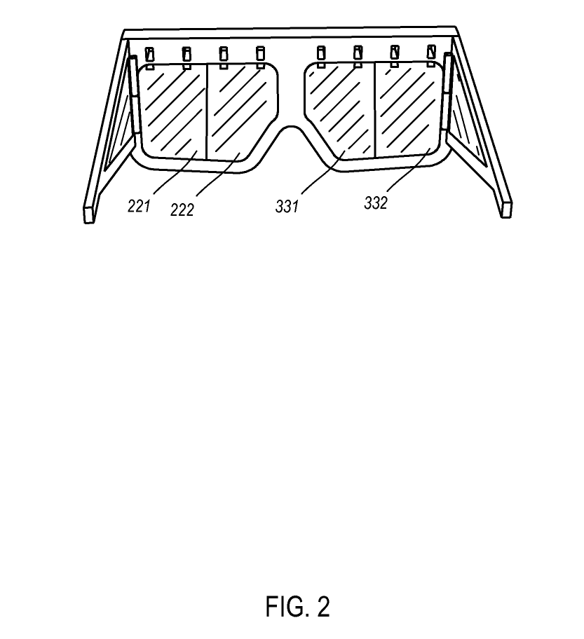

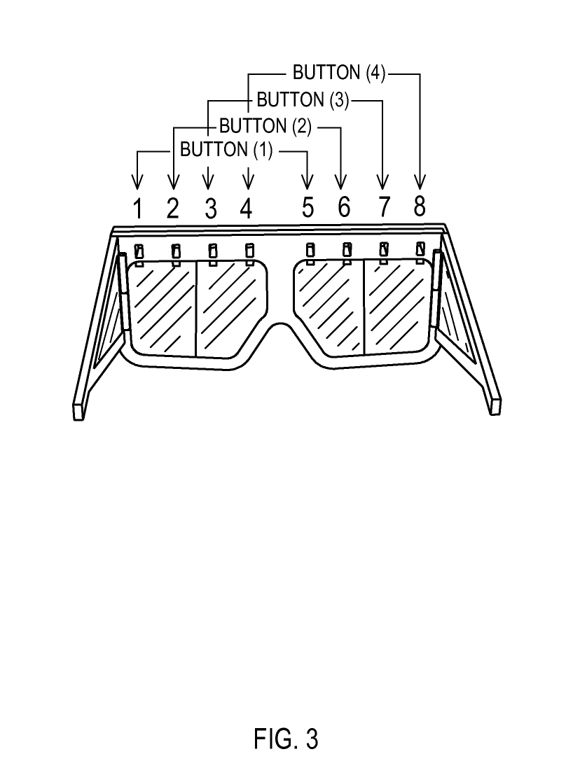

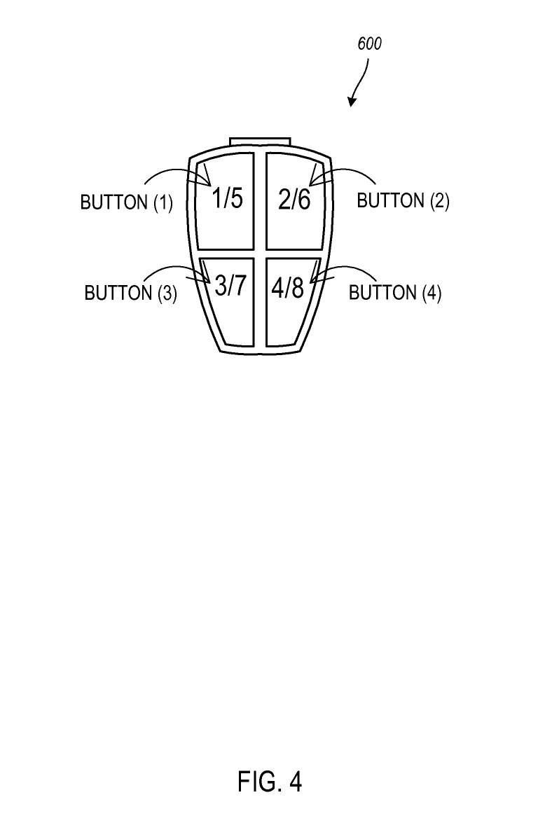

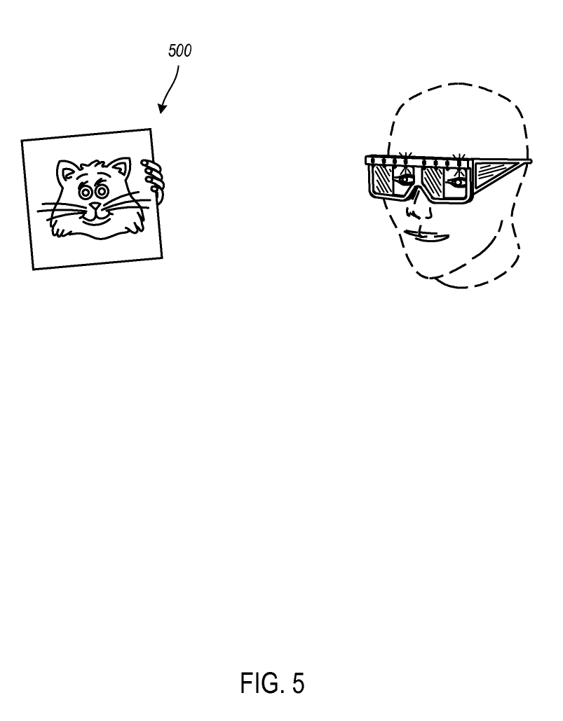

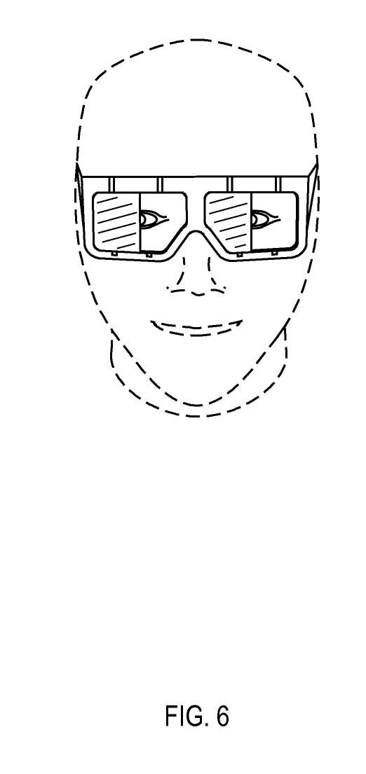

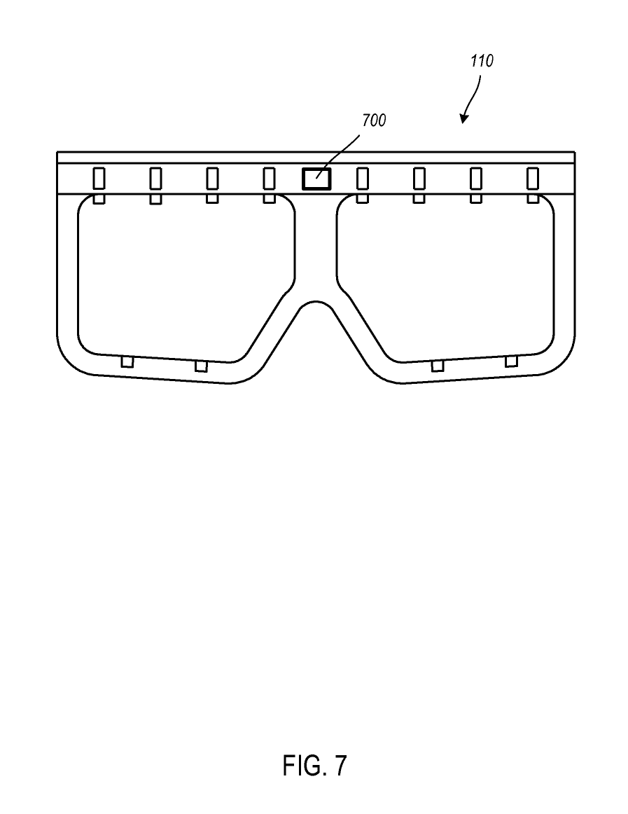

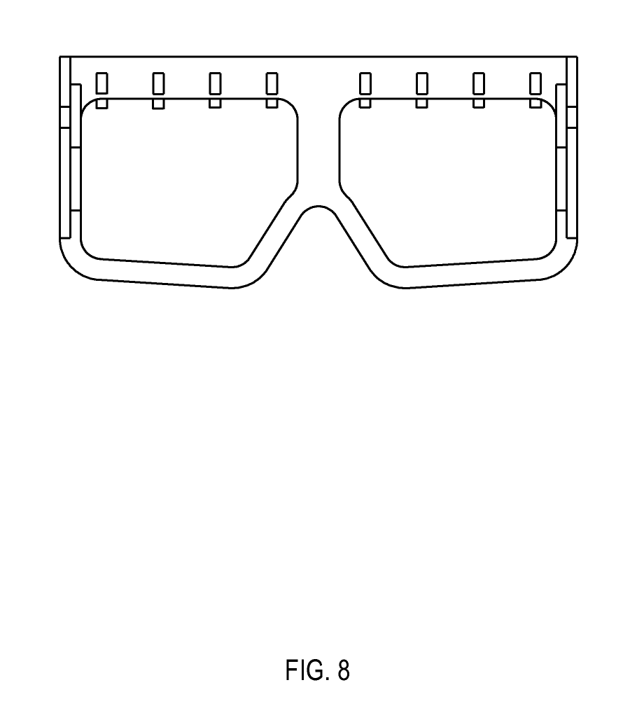

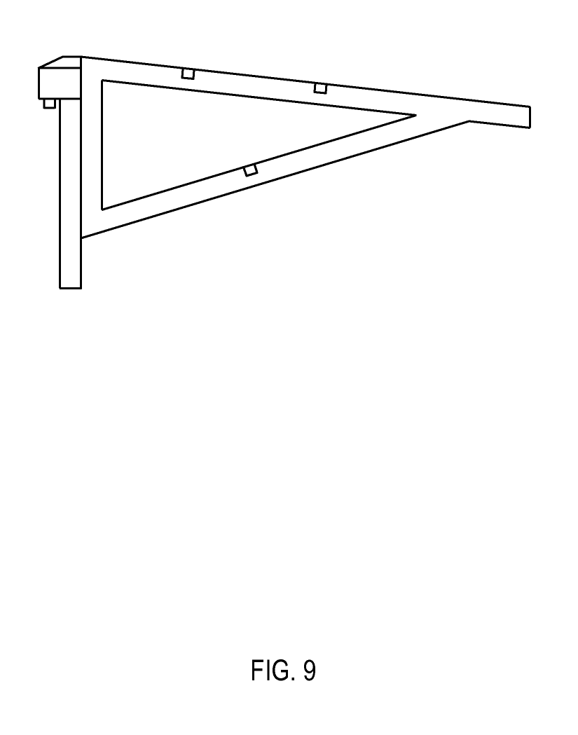

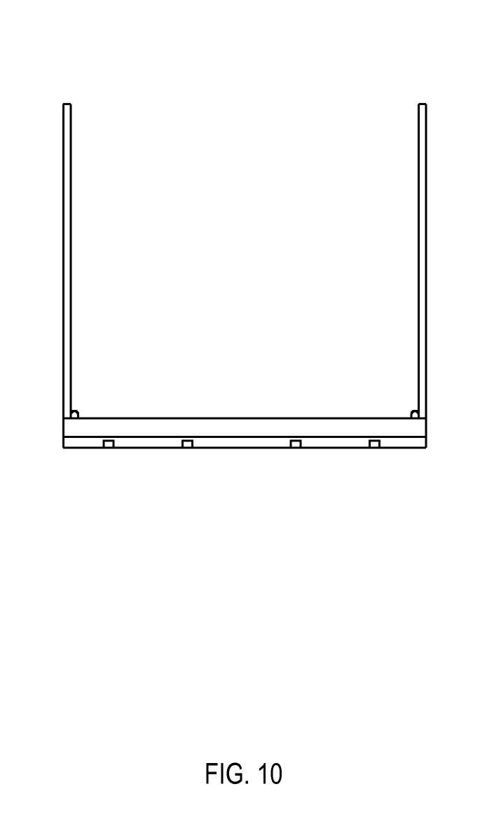

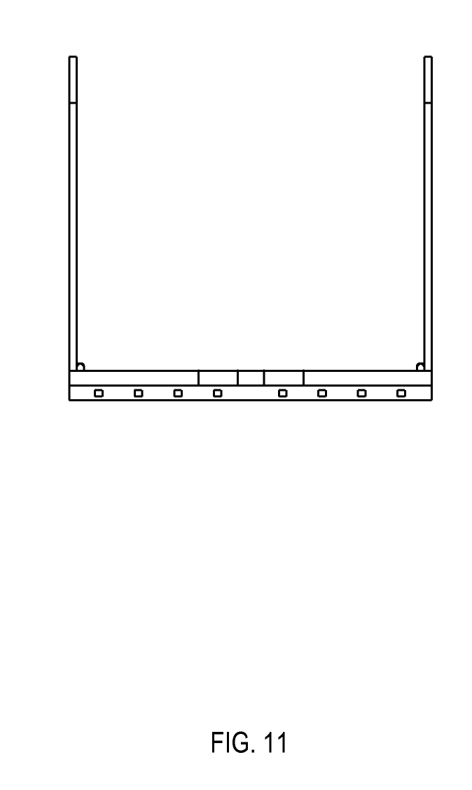

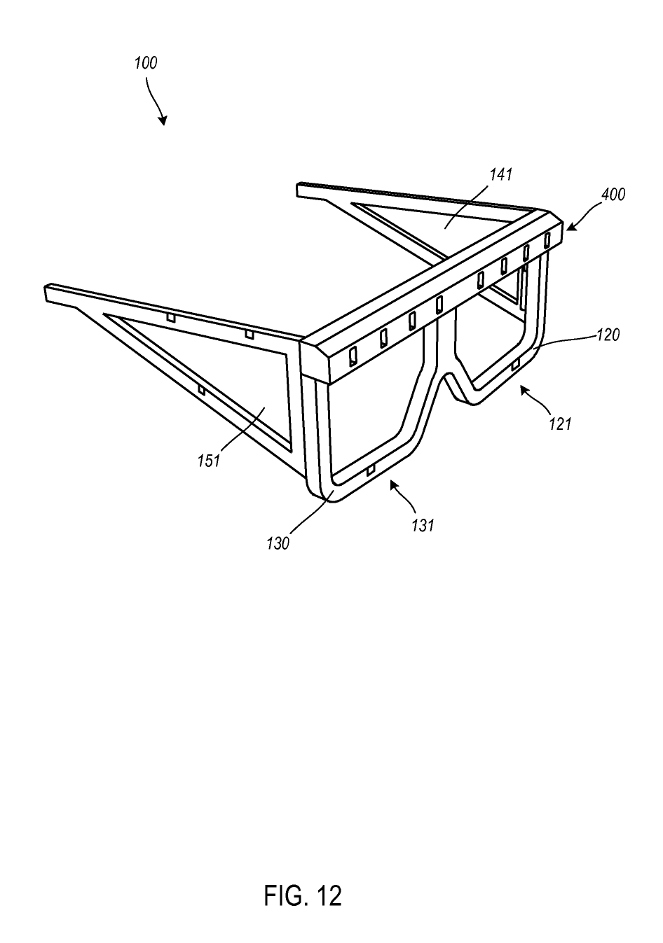

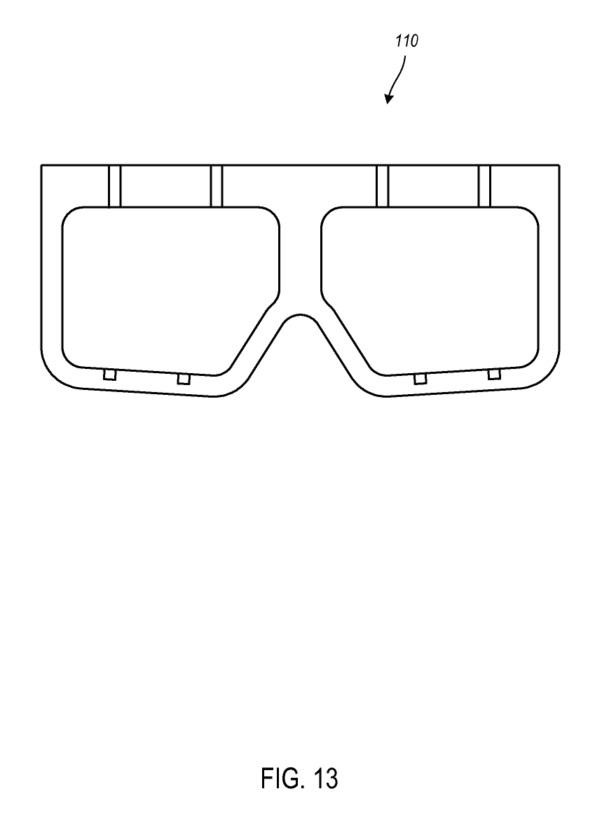

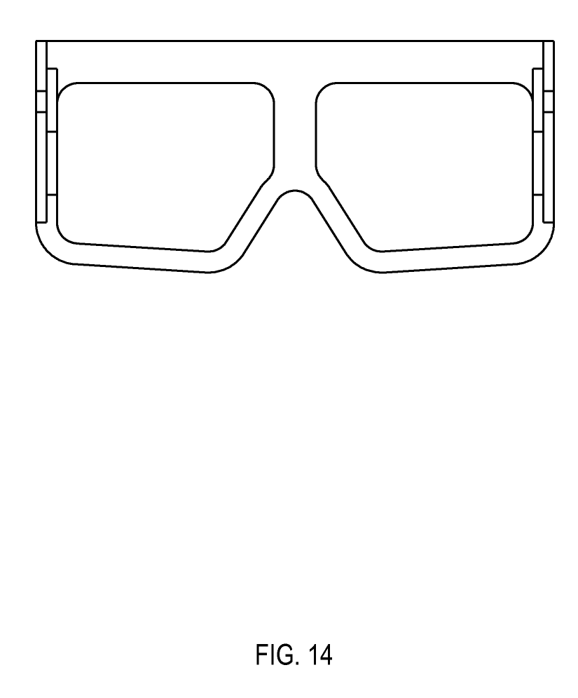

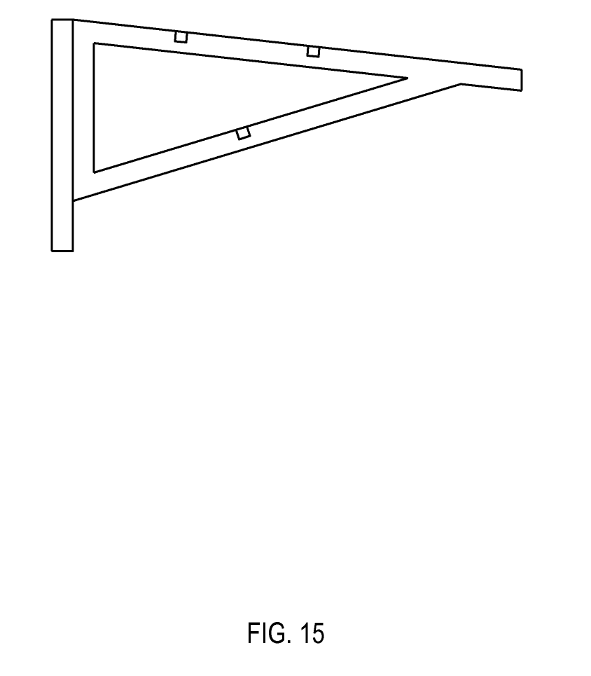

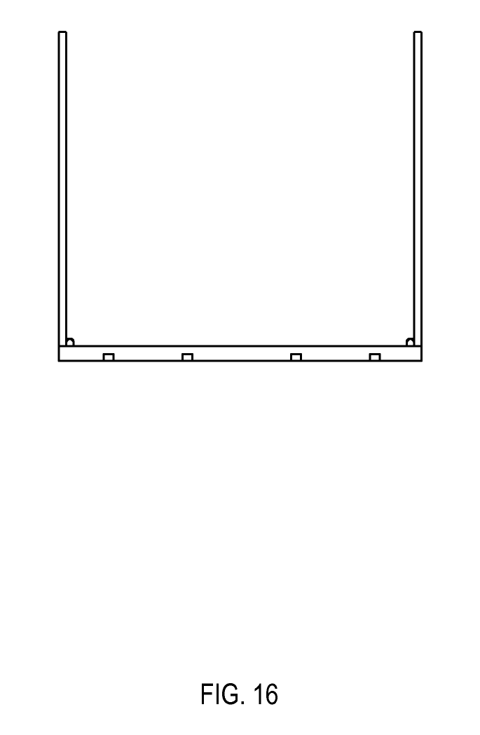

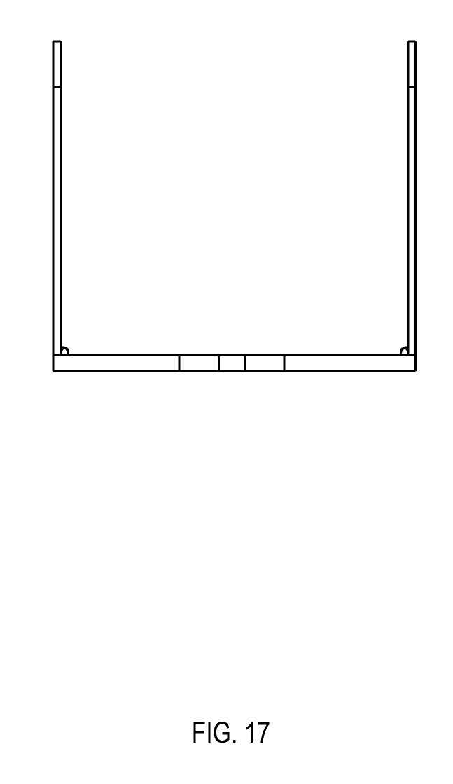

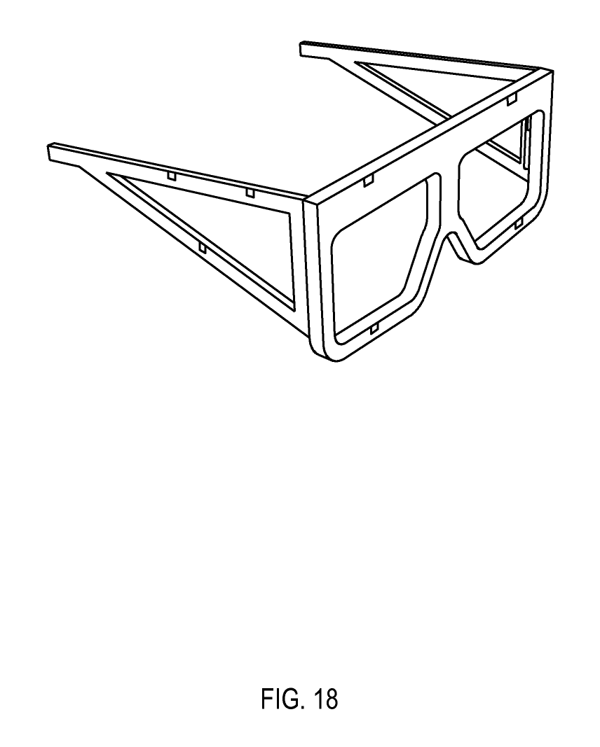

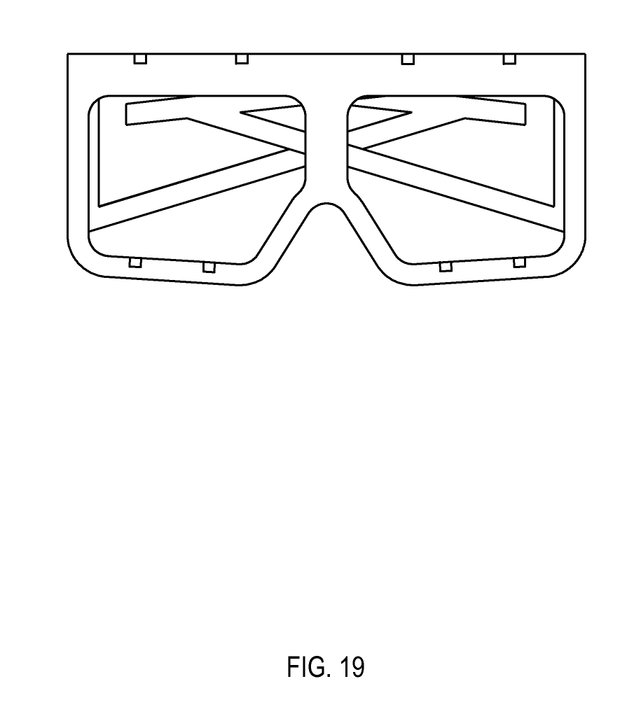

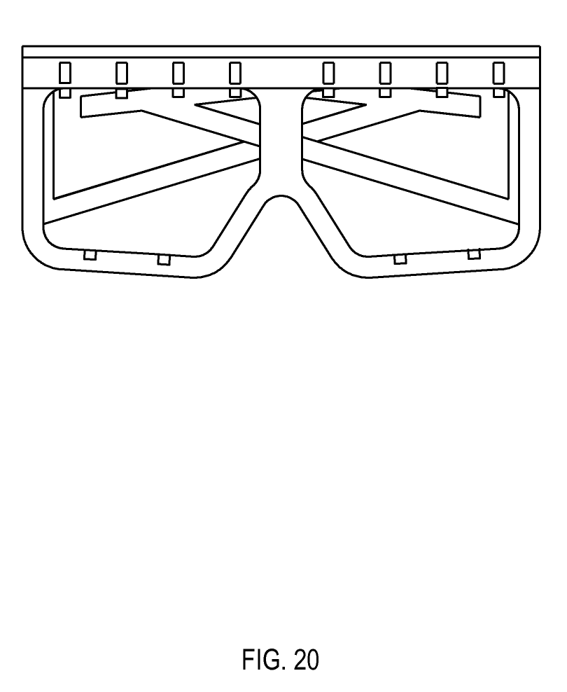

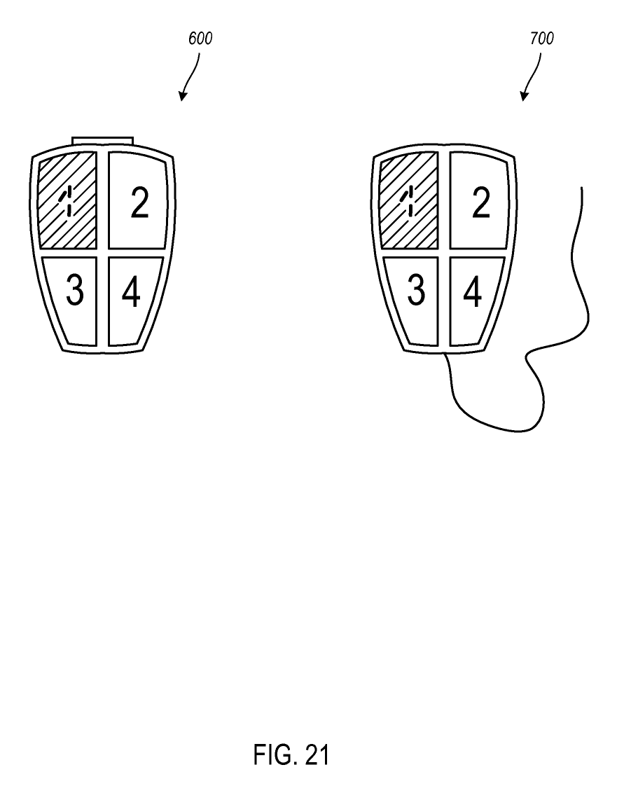

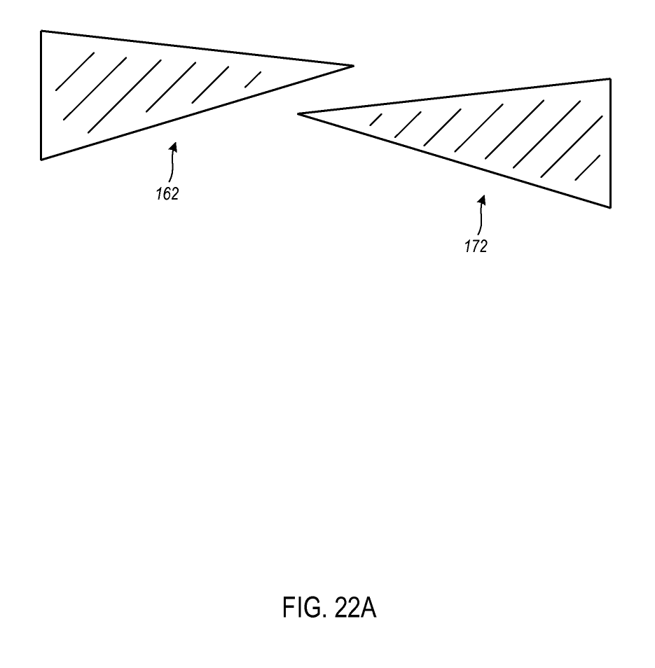

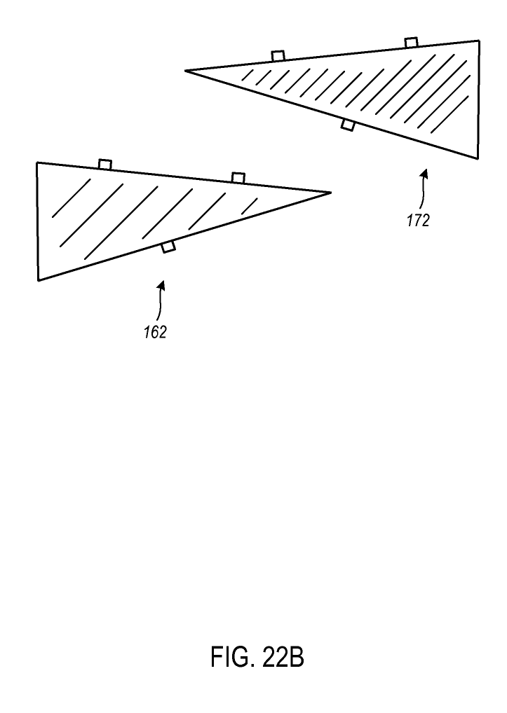

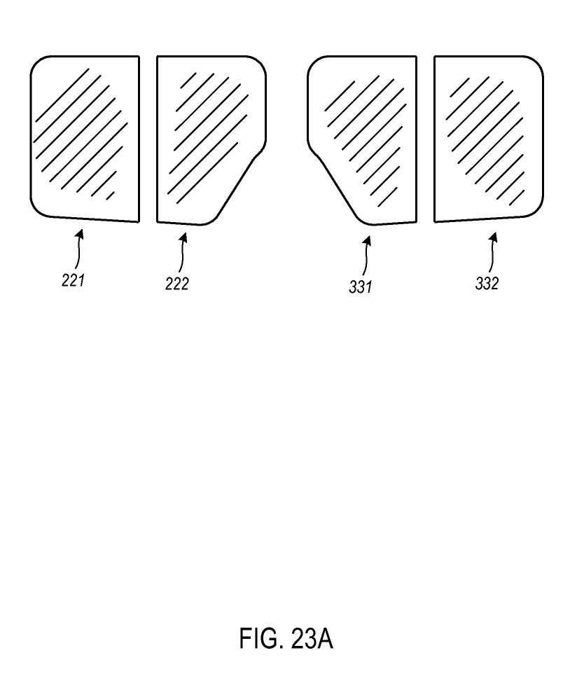

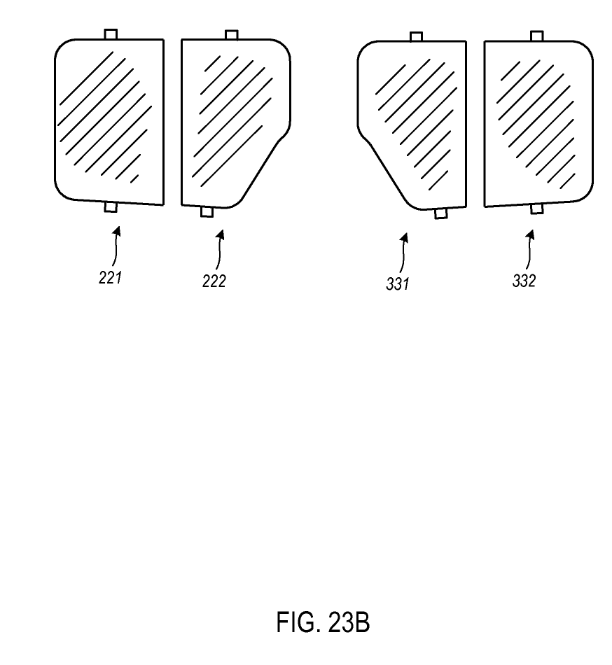

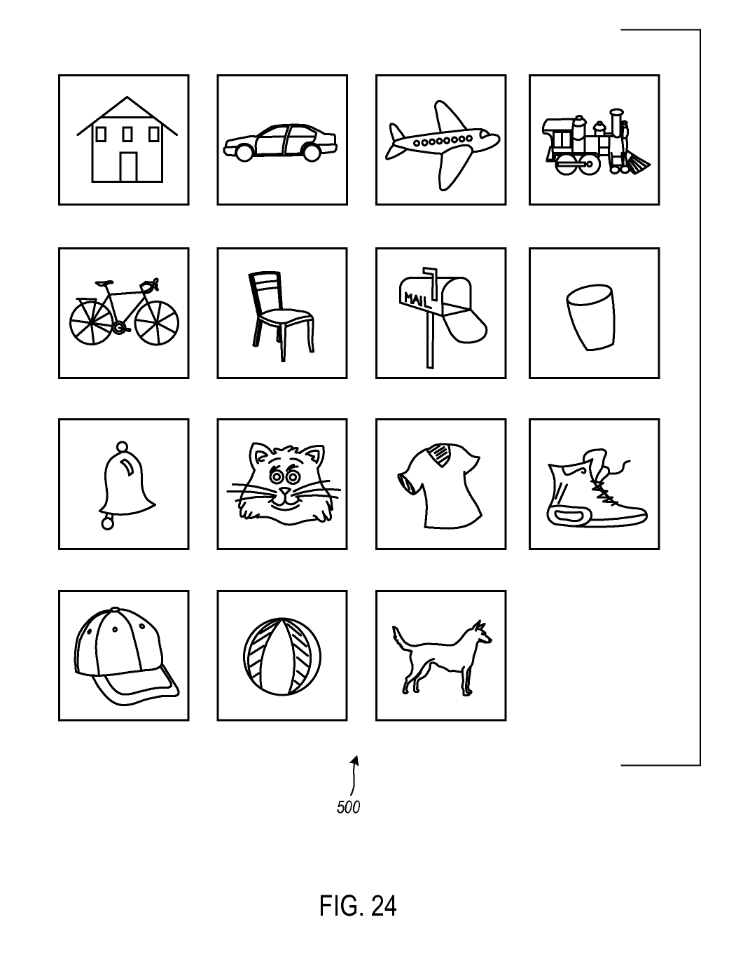

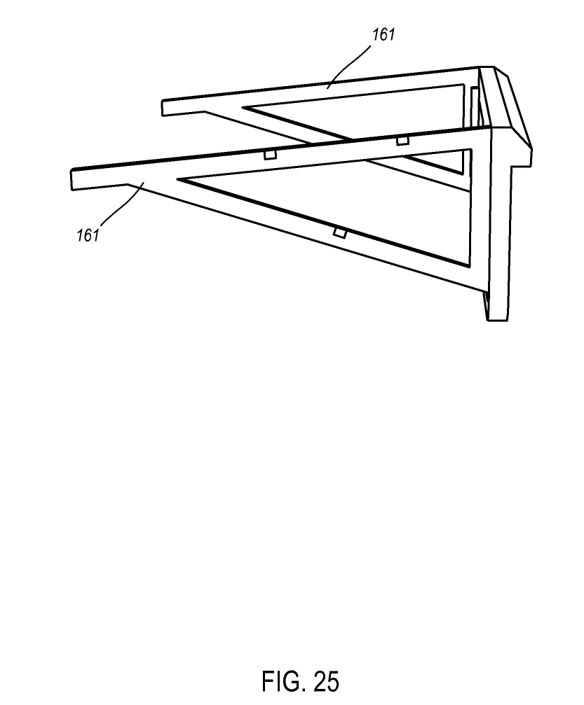

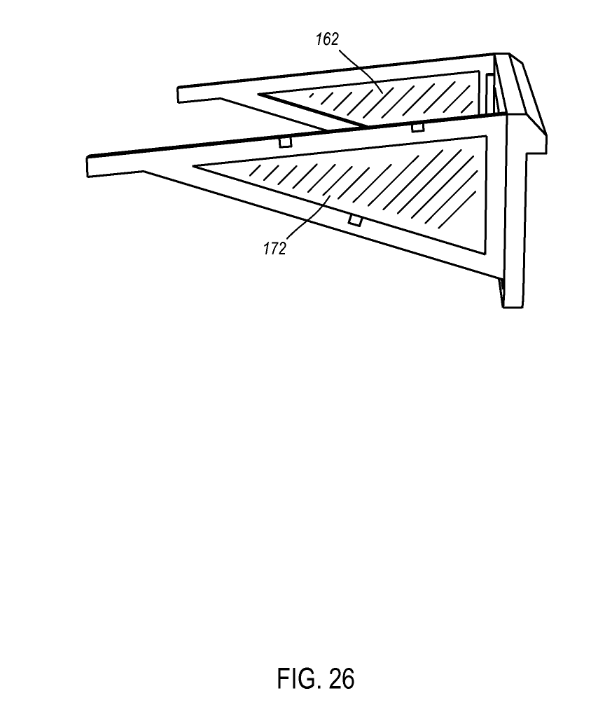

Referring now to FIGS. 1-26, an eyewear device 100 is shown, comprised of eyewear frames 110 having a left rim 120, a left lens area 121, a right rim 130 having a right lens area 131, a left side lens area 141 and a right side lens area 151.

In one embodiment of the technology described herein eyewear frames 110 for the treatment of unilateral neglect syndrome experienced by a subject comprises a left rim 120 having a left lens area 121 for receiving a first left lens 221 and a second left lens 222, the first and second left lenses configured for placement in the left lens area 121 individually or in combination, adjacent one to another; a right rim 130 having a right lens area 131 for receiving a first right lens 331 and a second right lens 332, the first and second right lenses configured for placement in the right lens area 131 individually or in combination, adjacent one to another; a plurality of light-emitting diodes (LEDs)/light emitting sources 400 disposed upon the eyewear frames and configured to emit a plurality of varied light patterns toward a subject wearing the eyewear frames to provide stimulation, the plurality of LEDs/light emitting sources also configured for visibility to a non-wearer from a front, outward side of the eyewear frames. The eyewear frames 110 are configured for disposition upon a subject, and a left eye and a right eye are partially or fully occluded in a plurality of varied patterns, to aid in the treatment of unilateral neglect syndrome and stimulate response in a neglected side of the body of the subject.

The eyewear device does not utilize mirrors or prisms as a medium for treatments. Additionally, the eyewear device does not use hinges to couple components of the device together.

In at least one embodiment, the eyewear frames also include: a left end piece 161 coupled to the left rim 120 and having a left temple area; a right end piece 171 coupled to the right rim 130 and having a right temple area; a removable left temple block 162, configured for placement within the left temple area; and a removable right temple block 172, configured for placement within the right temple area; and where the eyewear frames 110 are configured for disposition upon a subject, and a left eye and a right eye are partially or fully occluded in a plurality of varied patterns, to aid in the treatment of unilateral neglect syndrome and stimulate response in a neglected side of the body of the subject.

In at least one embodiment, the plurality LEDs/light emitting sources disposed upon the eyewear frames 110 are further configured to operate in pairs or any sequence thereof, thereby able to illuminate one or more LEDs/light emitting sources simultaneously, one or more LEDs/light emitting sources proximate to the left eye, and one or more LEDs/light emitting sources proximate to the right eye, thereby operative to draw the left and right eyes to scan and track toward a target direction.

In at least one embodiment the device also includes a wireless or wired remote control 600 configured for connectivity to the plurality of LEDs/light emitting sources disposed upon the second pair of eyewear frames 110 and configured to variably light the LEDs/light emitting sources to provide varied stimulation to the eyes of the subject.

In at least one embodiment the wireless remote control 600, or alternatively the wired remote 700, is configured with a number of buttons that correlated to the number of the plurality of LEDs/light emitting sources disposed upon the second pair eyewear frames 110, and wherein each button is configured to, upon depression of the button, to illuminate numerous LEDs/light emitting sources, one or more proximate to the left eye and one or more proximate to the right eye, thereby operative in tandem, or any other sequence, to draw the left and right eyes to scan and track toward a target direction.

In at least one embodiment the device further includes a plurality of flashcards 500. Each flashcard 500 has a unique thematic, illustrated diagram. The plurality of flashcards 500 is configured for display one-at-a-time, or any other sequence, to the subject to obtain a plurality of test data and measure progress of the treatment for unilateral neglect syndrome.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. Eyewear frames for the treatment of unilateral neglect syndrome experienced by a subject, the eyewear frames comprising:
a left rim having a left lens area for receiving a first and a second left lens, the first and second left lenses configured for placement in the left lens area individually or in combination, adjacent one to another;
a right rim having a right lens area for receiving a first and a second right lens, the first and second right lenses configured for placement in the right lens area individually or in combination, adjacent one to another;
a plurality of light-emitting diodes (LEDs)/light emitting sources disposed upon the eyewear frames and configured to emit a plurality of varied light patterns toward a subject wearing the eyewear frames to provide stimulation, the plurality of LEDs/light emitting sources also configured for visibility to a non-wearer from all possible fields of vision for a non-wearer of the eyewear frames; and
wherein the eyewear frames are configured for disposition upon the subject, and a left eye and a right eye are partially or fully occluded in a plurality of varied patterns, to aid in the treatment of unilateral neglect syndrome and stimulate response in a neglected side of the body of the subject.

2. The eyewear frames of claim 1, further comprising:
a left end piece coupled to the left rim and having a left temple area;
a right end piece coupled to the right rim and having a right temple area;
a removable left temple block, configured for placement within the left temple area; and
a removable right temple block, configured for placement within the right temple area.

3. The eyewear frames of claim 1, wherein the plurality of LEDs/light emitting sources disposed upon the eyewear frames are further configured to extend from the left rim and the right rim for placement in a line of vision of the subject through the left lens area and the right lens area.

4. The eyewear frames of claim 1, wherein the plurality of LEDs/light emitting sources disposed upon the eyewear frames are further configured to operate in pairs or any other applicable sequence, thereby able to illuminate several LEDs/light emitting sources simultaneously, one or more LED/light emitting sources proximate to the left eye, and one or more LED/light emitting sources proximate to the right eye, thereby operative in tandem, or any other applicable sequence, to draw the left and right eyes to scan and track toward a target direction.
